(19) United States
(12) Patent Application Publication
(10) Pub. No.: US 2008/0082626 A1
(43) Pub. Date: Apr. 3, 2008

(54) TYPED AUTHORIZATION DATA

(75) Inventors: Christopher G. Kaler, Sammamish, WA (US); Douglas A. Walter, Redmond, WA (US); Arun K. Nanda, Sammamish, WA (US); Hervey O. Wilson, Bellevue, WA (US)

Correspondence Address: WORKMAN NYDEGGER/MICROSOFT, 1000 EAGLE GATE TOWER, 60 EAST SOUTH TEMPLE, SALT LAKE CITY, UT, 84111, US

(73) Assignee: MICROSOFT CORPORATION, Redmond, WA (US)

(21) Appl. No.: 11/536,996

(22) Filed: Sep. 29, 2006

(51) Int. Cl. G06F 15/16

(52) U.S. Cl. 709/217; 709/218; 709/203

(57) ABSTRACT

Requesting security tokens with typed information. A method includes accessing at a client, information to allow the client to request a token for accessing functionality of a service. The method further includes sending a client request from the client to a token issuer in a token request. The client request includes the information and at least one of information defining the source of the information, proof of the source of the information; or usage information specifying how the information should be used.

### BACKGROUND

### Background and Relevant Art

Computers and computing systems have affected nearly every aspect of modern living. Computers are generally involved in work, recreation, healthcare, transportation, entertainment, household management, etc. The functionality of computers has also been enhanced by their ability to be interconnected through various network connections.

Modern computers often include functionality for connecting to other computers. For example, a modern home computer may include a modem for dial-up connection to internet service provider servers, email servers, directly to other computers, etc. In addition, nearly all home computers come equipped with a network interface port such as an RJ-45 Ethernet port complying with IEE 802.3 standards. This network port, as well as other connections such as various wireless and hardwired connections can be used to interconnect computers.

Often, when communicating with one another, computer systems require an authentication process to take place to verify identities and ensure that a computer system has appropriate rights to services being requested. One method of performing this authentication process includes requests for and issuance of security tokens. Security tokens can be presented by a computer system, to a service which has functionality that the computer system desires to access. The security token can be used to verify the identity of the computer system. Security tokens can also be used to indicate that an entity has access rights to given functionality.

Illustrating now an exemplary case, a client system may have use for accessing functionality at a service. However, before accessing the service, the client may request a token from a token issuer service. The token issuer service acts as a third party that is trusted by both the client system and the service which the client wants to access. The token includes personally identifying information for the client in the token that is returned to the client. The token also includes other information, such as a certificate, that indicates that the token was issued by the token issuer service. The token can then be presented by the client to the service that the client desires to access. Because the service trusts the token issuer service, the token will be accepted and the services provided to the client.

Generally, tokens can be issued based on information passed from the client to the token issuer authenticating the client and based on access control lists at the token issuer. For example, a client can make a claim in a token request, where the claim includes such things as usernames and passwords. The claim is then evaluated against information in the access control list. A determination about whether or not to issue a token can be based on this evaluation.

However, there are some occasions when additional information from other sources is useful. For example, preauthorization information from a service may be desired. In other situations, specialized environmental and contextual information may be desired.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

One embodiment illustrated herein includes a method practiced in a computing environment including at least a client, a service including functionality accessible by the client, and a token issuer. The method includes various acts for requesting security tokens. The method includes accessing at the client, information to allow the client to request a token for accessing the functionality of the service. The method further includes sending a client request from the client to the token issuer in a token request. The client request includes the information and at least one of information defining the source of the information, proof of the source of the information or usage information specifying how the information should be used.

Another embodiment illustrated herein is another method that may be practiced in a computing environment including at least a client, a service including functionality accessible by the client, and a token issuer. The method includes acts for providing security tokens. The method includes receiving at the token issuer, a client request in a token request. The client request includes information from a service and at least one of information defining the source of the information from the service, proof of the source of the information from the service, or usage information specifying how the information should be used. A token is issued to the client based on at least one of the source of the information from the service, proof of the source of the information from the service or usage information specifying how the information should be used.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1 illustrates an environment where typed information can be passed from a client to a token issuer;

FIG. 2 illustrates a method of requesting a token; and

FIG. 3 illustrates a method of issuing a token.

### DETAILED DESCRIPTION

Embodiments herein may comprise a special purpose or general-purpose computer including various computer hardware, as discussed in greater detail below.

One embodiment described herein allows for typed information, or information of a given type, to be sent in a security token request. With the typed information is also included information such as source of the information, proof of source of the information, and usage information. This information can be used by the token issuer in the process of providing a token. For example, the typed information may be information conveying a purchase price. The source information may be a service that provides the purchase price to the client. The proof of source information may be some type of cryptographic or tokenized proof that the service sent the purchase price typed information. Some or all of this information may be sent by the client to a token issuer in a token request. The information can then be used by the token issuer to authorize issuance of the token, generate logging information, generate specific information to be included in the token, or for other purposes.

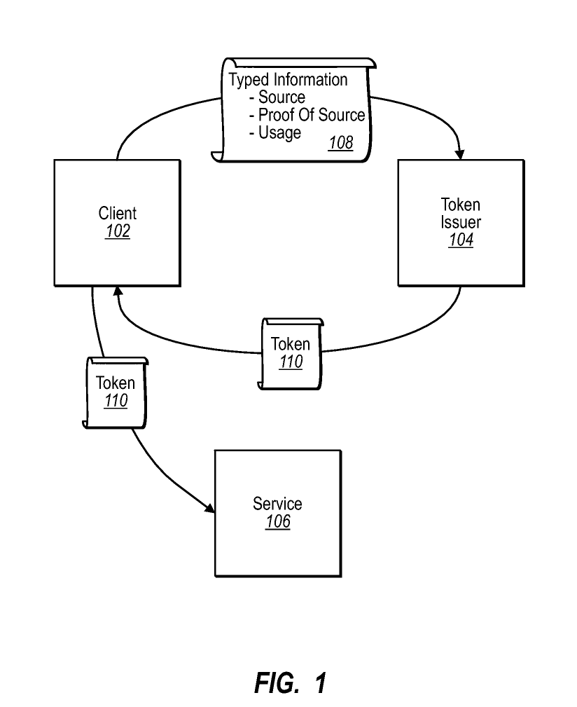

Referring now to FIG. 1, an exemplary embodiment is illustrated. FIG. 1 illustrates a client 102, a token issuer 104 and a service 106. The service 106 may have functionality which the client 102 may wish to access. To access the functionality of the service 106, the service 106 may require that the client 102 provide appropriate credentials such as a token issued from a third party token issuer 104. The client 102 may send a request 108 to the token issuer 104 to request a token 110. The token 110 can then be presented to the service 106 to access the functionality of the service 106.

As illustrated and FIG. 1, the request 108 may include typed information. Typed information is information that has independent contextual significance. The information itself has a value which is a value of the information. For example, one example of typed information may be a purchase price. The purchase price may have a monetary value. The typed information may further be of a particular format, which may affect the value. For example, if the format of the purchase price is U.S. dollars, then the value of the purchase price will have a specific numeric value corresponding to the purchase price in U.S. dollars.

FIG. 1 further illustrates that the request may also include information regarding the source of the typed information. The source information is not an indication that the client 102 is the source from which the token issuer 104 receives the information, but rather an indication of as source from where the client got the typed information from. For example, the service 106 may provide typed information to the client 102. The client 102 can then provide the typed information to the token issuer 104 along with information indicating that the service 106 is the source of the typed information.

Additionally, the source does not need to be the direct source. For example, if the service 106 receives the information from an application on the service 106, the source information in the request 108 may indicate the source as the service 106, the application on the service 106 or both the service 106 and the application on the service 106. Similarly, if the service 106 receives the information from another service or external source, information about the external source may be conveyed in the source information in the request 108.

In one embodiment, the client 102 may receive the typed information from an application running directly on the client 102. In this example, the source information in the request 108 will indicate that the source is the application on the client 102. Other sources, although not specifically enumerated here, may also be indicated.

FIG. 1 further illustrates that the request 108 may include proof of source information. The proof of source information may be some type of verifiable proof of where the typed information came from. For example, the proof of source may be cryptographic proof provided with the typed information indicating the source of the typed information. In one embodiment, the proof of source information may be a certificate indicating the source of the information. The certificate may be for example, a self generated certificate from the source of the information, a certificate from a third party certificate issuer, or a certificate from any other appropriate source.

FIG. 1 also illustrates that the request 108 may include usage information. The usage information may include information indicating how the typed information should be used and/or processed. The usage information may indicate, for example, a target service to which the information applies. For example, the usage information may specify that the typed information should be used for primary authentication on an authentication service on the token issuer 104. For example, the typed information may be the primary information used to authenticate the client 102 to determine that the client 102 is authorized to receive the token 110 from the token issuer 104.

Alternatively, the usage information may indicate that the typed information is to be used for secondary authentication. Specifically, other information may be used as primary authentication, with the typed information being used as secondary authentication. Thus, the usage information may indicate that the typed information is not suitable for primary authentication, but is suitable for secondary authentication when other information is used for primary authentication.

The usage information may indicate that the typed information is to be used for informational purposes only. This can be an indication that the typed information is not to be used for authentication or other security purposes, but rather is provided for various informational purposes. For example, in one embodiment, the usage information may specify that the typed information should be logged. Notably, the usage information may indicate that a combination of uses are appropriate. For example, the usage information may indicate that the information is to be used for authentication purposes, but that the information should or may also be logged.

Other information may be sent with the typed information as well. For example, type information may be sent specifying what the information represents. In one embodiment, format information may be sent specifying how the information is presented.

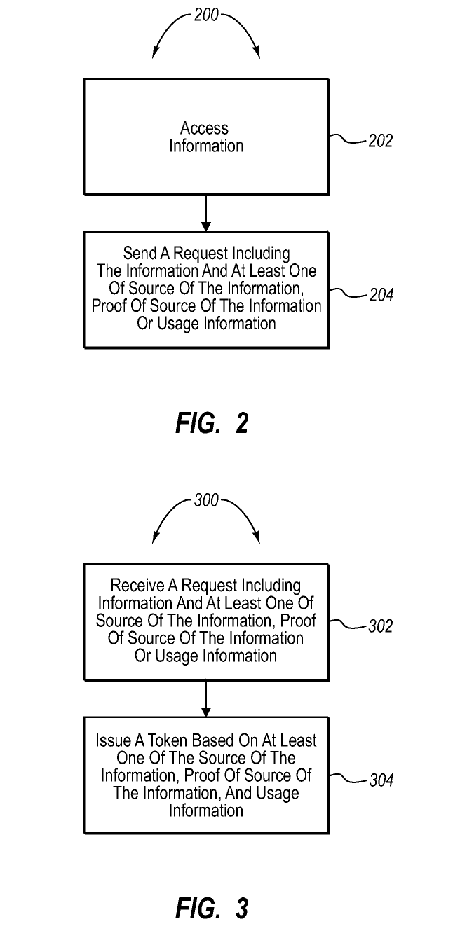

Referring now to FIG. 2, a method 200 is illustrated for requesting security tokens. The method may be practiced, for example, in a computing environment including a client, a service including functionality accessible by the client, and a token issuer. The method includes, accessing information at the client (act 202). The information may allow the client to request a token for accessing the functionality of the service. The information may be accessed at the client in a number of different ways. For example, the information may be accessed accessing an application locally on the client that provides the information. In an alternative embodiment, the information may be accessed by receiving the information from an external source. For example, and referring to FIG. 1, the information may be accessed by receiving the information from the service 106.

The method 200 further includes sending a request from the client including the information and at least one of information defining the source of the information, proof of the source of the information; or usage information specifying how the information should be used (act 204).

In one embodiment, as explained previously, the usage information may specify that the information should be used as primary authentication. In an alternative embodiment, the usage information specifies that the information should be used as secondary authentication. In some embodiments, the usage information may specify that the information should be used for information purposes. For example, the usage information may specify that the information should be logged.

In one embodiment, when proof of the source information is included, the proof of source information may include cryptographic proof from the service. Similarly, the proof of source information may include a certificate from the service.

In one embodiment of the method 200, sending a client request (204) from the client to the token issuer for a token may include sending the information in a non-tokenized portion of the request. Specifically, a request may include both tokenized and non-tokenized data. The information, as well as the source, proof of source and/or usage information may be sent in non-tokenized portions of the request.

Referring now to FIG. 3, another embodiment is illustrated. The embodiment illustrate in FIG. 3 is a method 300 for providing security tokens. The method may be practiced, for example, in a computing environment including at least a client, a service including functionality accessible by the client, and a token issuer. The method includes receiving at the token issuer, a client request in a token request (act 302). The client request includes information from a service and at least one of information defining the source of the information from the service, proof of the source of the information from the service; or usage information specifying how the information should be used. For example, as illustrated in FIG. 1, the token issuer 104 may receive a request 108 form the client 102. The request 108 includes information and one or more of source information, proof of source information, and/or usage information as outlined previously herein.

The method 300 further includes issuing a token to the client based on at least one of the source of the information from the service, proof of the source of the information from the service; or usage information specifying how the information should be used (act 304).

Embodiments may also include computer-readable media for carrying or having computer-executable instructions or data structures stored thereon. Such computer-readable media can be any available media that can be accessed by a general purpose or special purpose computer. By way of example, and not limitation, such computer-readable media can comprise physical media such as RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media.

Computer-executable instructions comprise, for example, instructions and data which cause a general purpose computer, special purpose computer, or special purpose processing device to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. In a computing environment including at least a client, a service including functionality accessible by the client, and a token issuer, a method of requesting security tokens, the method comprising:
accessing at the client, information to allow the client to request a token for accessing the functionality of the service; and
sending a client request from the client to the token issuer in a token request, the client request including the information and at least one of information defining the source of the information, proof of the source of the information or usage information specifying how the information should be used.

2. The method of claim 1, wherein the usage information specifies that the information should be used as primary authentication.

3. The method of claim 1, wherein the usage information specifies that the information should be used as secondary authentication.

4. The method of claim 1, wherein the usage information specifies that the information should be used for information purposes.

5. The method of claim 1, wherein the usage information specifies that the information should be logged.

6. The method of claim 1, wherein the proof of source information comprises cryptographic proof from the service.

7. The method of claim 1, wherein the proof of source information comprises a certificate from the service.

8. The method of claim 1, wherein sending a client request from the client to the token issuer for a token comprises sending the information in a non-tokenized portion of the request.

9. The method of claim 1, wherein the information is typed information, and wherein the method further comprising sending type information specifying what the information represents.

10. The method of claim 1, further comprising sending format information specifying how the information is presented.

11. The method of claim 1, wherein accessing at the client, information to allow the client to request a token for accessing the functionality of the service comprises accessing information from an application locally at the client.

12. The method of claim 1, wherein accessing at the client, information to allow the client to request a token for accessing the functionality of the service comprises receiving information from the service.

13. In a computing environment including at least a client, a service including functionality accessible by the client, and a token issuer, a method of providing security tokens, the method comprising:
receiving at the token issuer, a client request in a token request, the client request including information from a service and at least one of information defining the source of the information from the service, proof of the source of the information from the service; or usage information specifying how the information should be used; and
issuing a token to the client based on at least one of the source of the information from the service, proof of the source of the information from the service or usage information specifying how the information should be used.

14. The method of claim 13, wherein the usage information specifies that the information should be used as primary authentication.

15. The method of claim 13, wherein the usage information specifies that the information should be used as secondary authentication.

16. The method of claim 13, wherein the usage information specifies that the information should be used for information purposes.

17. The method of claim 13, wherein the usage information specifies that the information should be logged.

18. The method of claim 13, wherein the proof of source information comprises cryptographic proof from the service.

19. The method of claim 13, wherein the proof of source information comprises a certificate from the service

20. A computer readable medium for use in a computing environment including at least a client, a service including functionality accessible by the client, and a token issuer, the computer readable medium comprising computer executable instructions for performing the following:
accessing at the client, information to allow the client to request a token for accessing the functionality of the service; and
sending a client request from the client to the token issuer in a token request, the client request including the information and at least one of information defining the source of the information, proof of the source of the information or usage information specifying how the information should be used.
